(19) United States
(12) Patent Application Publication
(10) Pub. No.: US 2014/0298479 A1
(43) Pub. Date: Oct. 2, 2014

(54) SECURE DATA TRANSFER FOR CHAT SYSTEMS

(71) Applicant: AYU Technology Solutions LLC, Houston, TX (US)

(72) Inventors: Adam Stass, Houston, TX (US); Dustin Yu, Houston, TX (US)

(73) Assignee: AYU Technology Solutions LLC, Houston, TX (US)

(21) Appl. No.: 14/243,672

(22) Filed: Apr. 2, 2014

Related U.S. Application Data
(60) Provisional application No. 61/807,652, filed on Apr. 2, 2013.

(51) Int. Cl. G06F 21/60; H04L 12/58

(52) U.S. Cl. CPC G06F 21/606; H04L 51/046
USPC 726/26

(57) ABSTRACT

The methods and systems disclosed herein pertain to secure data transfers during live chat sessions. At the conclusion of the chat session, any confidential information exchanged using the secure data transfer can be destroyed to maintain the confidentiality and/or privacy of the content of that information.

### CROSS REFERENCE TO RELATED APPLICATION

This application claims the benefit of U.S. Provisional Application No. 61/807,652 filed Apr. 2, 2013, which is herein incorporated by reference in its entirety.

### BACKGROUND

Live support software, also known as live chat or online chat, is used by many businesses to receive and respond to text communications from users. Although live support services can be used to exchange almost any type of information, caution must be exercised when exchanging confidential information using conventional chat systems because of the unsecured nature of the exchange. Accordingly, it is desirable to provide a system that can provide greater security when transfer and/or exchanging confidential or private information using live support software.

### SUMMARY

The methods and systems disclosed herein pertain to receiving and/or sending securing data using live support software (live chat).

In one representative embodiment, two or more users are engaged in a live chat session, such as a customer and a support agent. The two or more users can be exchanging text in real-time in a live chat session (synchronous live conversation). To provide for a secure exchange of data, one of the users (e.g., the customer) can activate a “Secure Data Transfer” feature. The activation of the secure data transfer feature can be performed, for example, by clicking on a “lock” icon on the chat window during the chat session.

After the secure data transfer feature is activated, a separate, embedded text area can be presented (e.g., separate from the chat text area) to the user (e.g., customer). The user can enter confidential or other private information (e.g., password, credit card information, etc.). The secure data transfer can be performed in parallel with the open chat session between the users. The user that is transmitting confidential information can click submit and the confidential information can be stored in a temporary “cache” which is in “memory” (e.g., not hard disk) on a server associated with the live chat session.

In some embodiments, the confidential information can be “masked” (e.g., entirely hidden) from the user transferring the information (e.g., the customer), but remain fully visible in the chat window of the user receiving the information (e.g., the agent).

After the chat session is ended, the chat transcript can be saved (e.g., in one or more databases), but the confidential information that was exchanged during the chat session is located and deleted from “cache”, so it will be not be saved in the database(s).

Accordingly, in this manner, confidential information is only stored while the chat session in progress and the confidential information is deleted or otherwise destroyed after the chat session has ended.

In some embodiments, a trace can be provided that identifies that a secure data transfer was performed. For example, one of the users (e.g., the agent) can see the exchanged confidential information until they close the chat box. If a chat report is run, however, only a “flag” indicates that there was a secure data transfer. Nothing about the exchanged information is available.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates an exemplary screenshot of a live chat session.

FIG. 2 illustrates an exemplary screenshot of a live chat session, in which a secure data transfer has been initiated.

FIGS. 3A and 3B illustrate exemplary screenshots from the perspective of a user transferring confidential information (e.g., a customer) and a user receiving confidential information (e.g., an operator or customer service agent).

FIG. 4 illustrates an exemplary screenshot of a live chat transcript after the chat session has ended, wherein the secure data transfer information is no longer saved or displayed.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

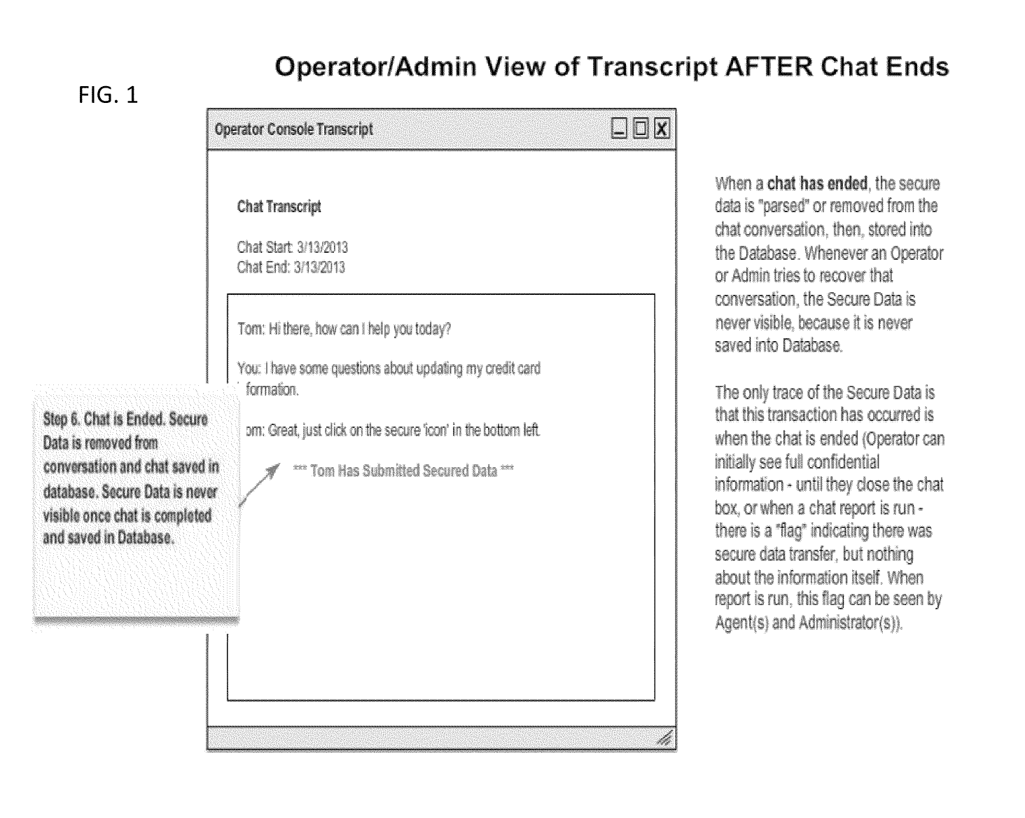

The secure data transfer procedures disclosed herein allow one or more users to exchange confidential and/or private information with another user during a chat session. In one representative embodiment, two or more users are engaged in a live chat session, such as a customer and a support agent. As shown in FIG. 1, a chat session has been initiated from a website (i.e., Bob's Plumbing Website) and the two or more users (e.g., a customer and customer service agent) are exchanging text in real-time in a live chat session. To provide for a secure exchange of data, one of the users (e.g., the customer) can activate a “Secure Data Transfer” feature. As shown in FIG. 1, the secure data transfer feature can be activated by clicking on an icon, such as the “lock” icon located at a lower left side of the chat window during the chat session. Preferably secure data transfer can only be initiated during a live chat conversation, where there is a clear start and end of the chat session.

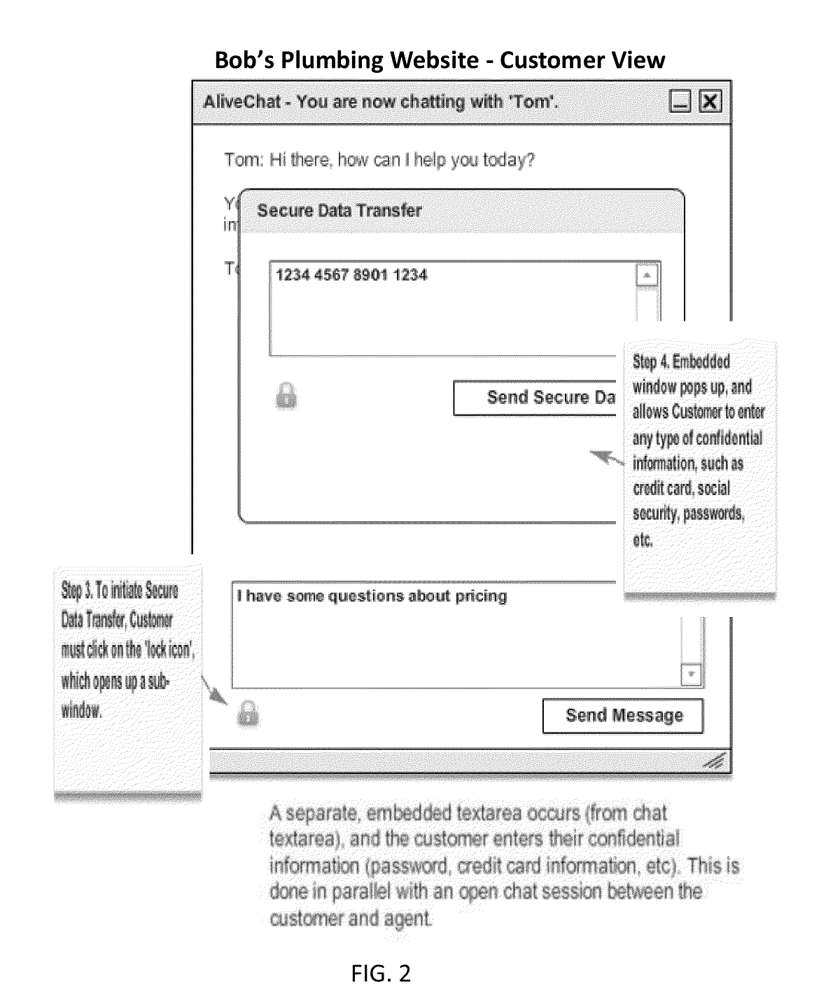

As shown in FIG. 2, after the secure data transfer feature is activated, a separate, embedded text area can be presented separate from the chat text area to the user. The user (e.g., the customer) can enter confidential or other private information (e.g., password, credit card information, etc.). The secure data transfer can be performed in parallel with the open chat session between the users. The user that is transmitting confidential information can click submit and the confidential information can be stored in a temporary “cache” which is in “memory” (e.g., not hard disk) on a server associated with the live chat session.

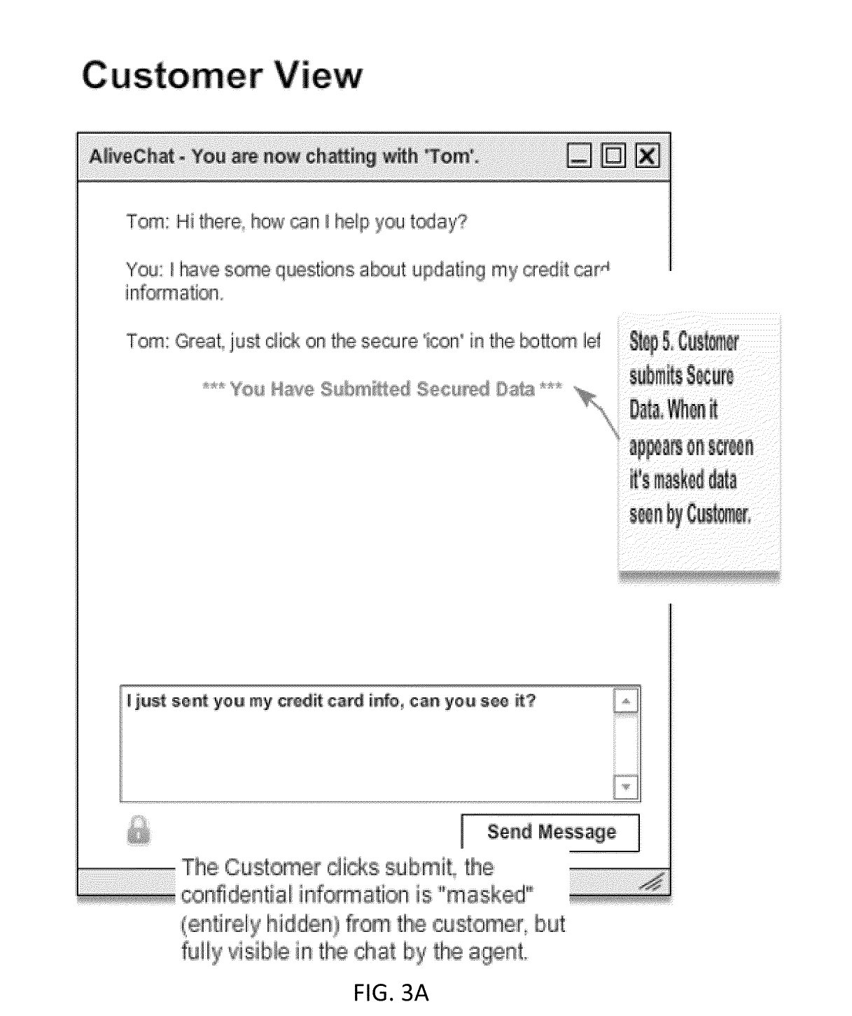

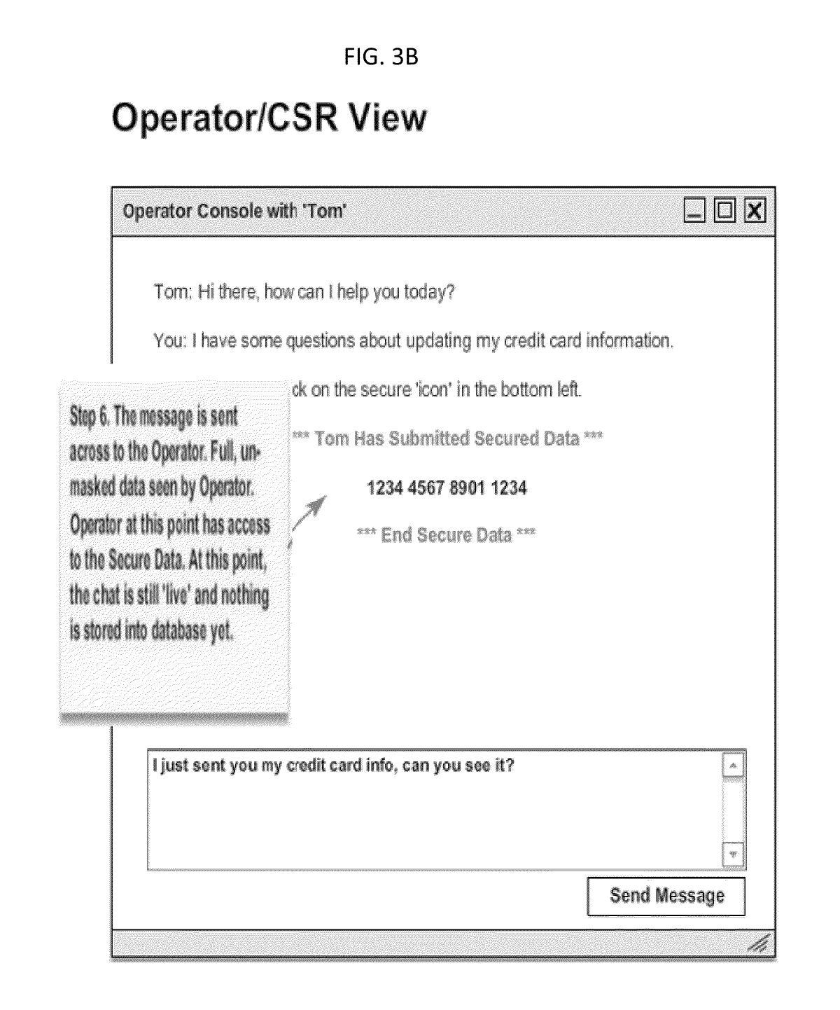

In some embodiments, once the confidential information has been sent by the user, it can be “masked” (e.g., entirely hidden) from the user that transferred the information (e.g., the customer), but remain fully visible in the chat window of the user receiving the information (e.g., the agent). This is illustrated, for example, in FIG. 3. As shown in FIG. 3, the user that exchanged the confidential information (e.g., the customer) only sees the indication that secure data was transferred, while the user that received the secure data can see the secured date in its entirety.

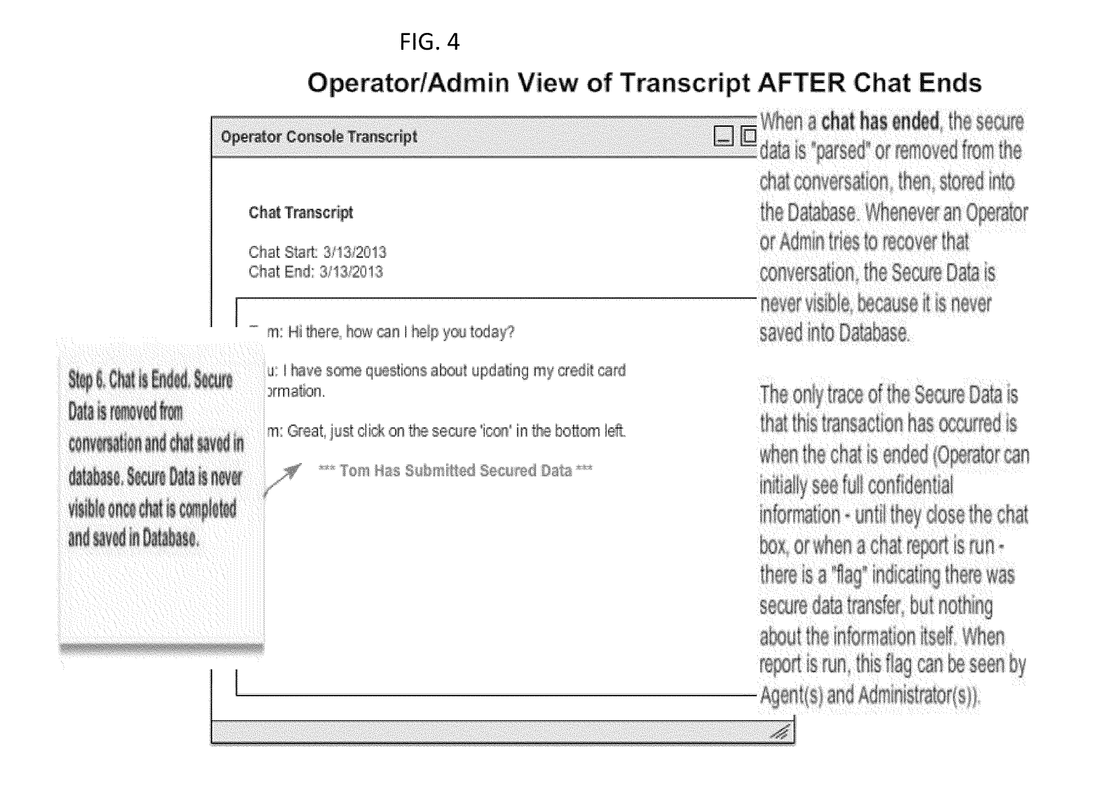

As shown in FIG. 4, after the chat session is ended, the chat transcript can be saved (e.g., in one or more databases), but the confidential information that was exchanged during the chat session is located and deleted from “cache”, so it will be not be saved in the database(s). If the stored data is later viewed, for example by an administrator or operator, the chat session will only reflect that secure data was transferred—it will not identify the content of that data. Accordingly, in this manner, confidential information is only stored while the chat session in progress and the confidential information is deleted or otherwise destroyed after the chat session has ended.

The secure data that is transferred by a user can comprise any confidential information that the user would want to be protected in a secure manner. For example, for online businesses the secure data can comprise credit card information or other financial information associated with a billing or sales event. In other embodiments, the secure data transfers can include health care information such as personal medical history information of the user. In still other embodiments, the confidential information can include financial information associated with the user, such as information relating to banking or retirement accounts. It should be understood that these are only examples of the type of confidential information that can be exchanged using the systems and methods disclosed herein. Such secure data transfers can be initiated any time one or more users would like to restrict later access to the

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of securely transferring data during a chat session, comprising:
receiving a chat request to initiate a chat session from a user;
initiating the chat session in response to the chat request by opening a chat window;
receiving a transfer request to initiate a secure data transfer from the user;
initiating the secure data transfer in response to the transfer request by opening a secure data transfer window;
receiving secure data from the user via the secure data transfer window and temporarily storing the secure data;
ending the chat session; and
after ending the chat session, destroying the stored secure data that was transferred from to the user via the secure data transfer widow.

2. The method of claim 1, wherein the secure data received from the user comprises credit card information of the user.

3. The method of claim 1, wherein the secure data received from the user comprises personal medical information about the user.

4. The method of claim 1, wherein the secure data received from the user comprises confidential identifying information about the user.

5. The method of claim 4, wherein the secure data comprises one or more social security numbers.
